(19) United States
(12) Patent Application Publication
(10) Pub. No.: US 2007/0093629 A1
(43) Pub. Date: Apr. 26, 2007

(54) Siloxane bishchloroformates

(75) Inventors: James Manio Silva, Clifton Park, NY (US); Gary Charles Davis, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/226,702

(22) Filed: Sep. 14, 2005

(51) Int. Cl. C08G 77/48

(52) U.S. Cl. 528/29; 528/14

(57) ABSTRACT

A continuous method for the preparation of bischloroformates of siloxane bisphenols, said method comprising introducing into a flow reactor and contacting therein at least one siloxane bisphenol, at least one metal hydroxide, at least one metal salt, at least one solvent and phosgene to form a flowing reaction mixture having an organic phase and an aqueous phase and forming bischloroformates of siloxane bisphenols in the flowing reaction mixture.

### BACKGROUND OF THE INVENTION

This invention relates to a method for the preparation of bischloroformates of siloxane bisphenols. More particularly the method relates to a continuous method for the preparation of bischloroformates of siloxane bisphenols in a flow reactor.

Bischloroformates of siloxane bisphenols are potentially attractive chemical intermediates for the preparation of silicone-containing materials, including silicone-containing copolycarbonates in which the silicone-containing monomer is incorporated into the polymer as an electrophilic species. Silicone-containing copolycarbonates such as siloxane copolycarbonates are prized for their unique combination of ductility, toughness, and flame retardancy. Siloxane copolycarbonates may be prepared by the reaction of a bischloroformates of siloxane bisphenols with suitable bisphenol.

It is of interest therefore, to develop new and more efficient processes for the formation of bischloroformates of siloxane bisphenols that overcome the limitations of known methods, and which achieve increased ease of operation and economic feasibility, while providing bischloroformates of siloxane bisphenols of high purity in high yield.

### BRIEF SUMMARY OF THE INVENTION

This specification provides a continuous method for the preparation of bischloroformates of siloxane bisphenols, said method comprising introducing into a flow reactor and contacting therein at least one siloxane bisphenol, at least one metal hydroxide, at least one aqueous soluble metal salt, at least one solvent and phosgene to form a flowing reaction mixture comprising an organic phase and an aqueous phase and forming bischloroformates of siloxane bisphenols in the flowing reaction mixture, wherein said phosgene is introduced at a rate such that the ratio of phosgene to siloxane bisphenol hydroxy groups is in a range between about 2.5 and about 6 moles of phosgene per mole of siloxane bisphenol hydroxy group, wherein said metal hydroxide is introduced as an aqueous solution, said aqueous solution having a concentration of at least about 5 percent by weight metal hydroxide, said metal hydroxide being introduced at a rate such that the molar ratio of metal hydroxide to phosgene is in a range between about 3.5 and about 6; and wherein the aqueous phase is characterized by an initial (i.e. feed) concentration of metal salt of at least about 1.5 percent by weight.

In another embodiment a method for preparing a siloxane copolycarbonate comprises:

reacting at least one dihydroxy aromatic compound, phosgene, at least one metal hydroxide, and at least one siloxane bischloroformate to form the siloxane copolycarbonate;

said siloxane bischloroformate having been prepared by a continuous method for the preparation of bischloroformates of siloxane bisphenols, said method comprising; introducing into a flow reactor and contacting therein at least one siloxane bisphenol, at least one metal hydroxide, at least one metal halide salt, at least one solvent and phosgene to form a flowing reaction mixture having an organic phase and an aqueous phase and forming bischloroformates of siloxane bisphenols in the flowing reaction mixture, wherein said phosgene is introduced at a rate such that the initial ratio of phosgene to siloxane bisphenol hydroxy groups is in a range between about 2.5 and about 6 moles of phosgene per mole of siloxane bisphenol hydroxy group, wherein said metal hydroxide is introduced as an aqueous solution, said aqueous solution having a concentration of at least about 5 percent by weight metal hydroxide, said metal hydroxide being introduced at a rate such that the initial molar ratio of metal hydroxide to phosgene is in a range between about 3.5 and about 6; and wherein the aqueous phase has an initial concentration of metal halide salt of at least about 1.5 percent by weight.

In another aspect, the present invention relates to the high purity bischloroformates of siloxane bisphenols which may be produced by the method of the present invention.

### DETAILED DESCRIPTION OF THE INVENTION

The present invention may be understood more readily by reference to the following detailed description of preferred embodiments of the invention and the examples included therein. In the following specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

The modifier “about” used in connection with a quantity is inclusive of the stated value and has the meaning dictated by the context (e.g., includes the degree of error associated with measurement of the particular quantity).

As used herein, the terms “siloxane-containing bischloroformates” and the term “siloxane bischloroformates” are used interchangeably and refer broadly to any bischloroformate comprising one or more siloxane units. In another aspect, the specification provides a method for making siloxane copolycarbonates.

As used herein, the term “bischloroformates of siloxane bisphenols” refers to bischloroformates prepared from siloxane-containing bisphenols or their equivalents. The disodium salt of a siloxane bisphenol is an example of a species which would function as the equivalent of a siloxane bisphenol

As used herein, the terms “siloxane-containing bisphenol” and “siloxane bisphenol” are interchangeable and have the same meaning. Siloxane bisphenols are dihydroxy aromatic compounds incorporating one or more siloxane repeat units. Typically, the siloxane bisphenols used to prepare the siloxane bischloroformates are isomeric mixtures, said isomeric mixtures arising in a double hydrosilylation reaction which is typically a synthetic step in the preparation of siloxane bisphenols. Typically, these isomeric mixtures comprise a single major isomer. It will be understood by those skilled in the art, however, that the Formula II given for the eugenol siloxane bisphenol used in the Examples and Comparative Examples is idealized in that it represents only the major isomer present in an isomeric mixture. Similarly, each of Formulas III-VIII represents an idealized structure meant to encompass instances in which said structures represent only a major isomer present in an isomeric mixture of siloxane bisphenols or siloxane bischloroformates. The description above should not be construed, however, as limiting the present invention to the use of isomeric mixtures of siloxane bisphenols. The use of siloxane bisphenols which are essentially single isomers falls well within the scope of the present invention.

As used herein, the term “d-50 eugenol siloxane bisphenol” indicates a eugenol siloxane bisphenol having idealized structure having Formula II wherein the number average value of the integer “m” is 50. The term “d-50 eugenol siloxane bisphenol” is abbreviated EuSiD50. For convenience the mixture of isomeric eugenol siloxane bisphenols used in the examples and comparative examples of the instant invention has been represented as a single structure, the structure of the major isomer present in said mixture, wherein average value of the integer “m” is 49.3.

“BPA” is herein defined as bisphenol A and is also known as 2,2-bis(4-hydroxyphenyl)propane; 4,4′-isopropylidenediphenol, and p,p-BPA.

As noted the present invention relates to a method for the continuous preparation of bischloroformates of siloxane bisphenols. By continuous, it is meant that reactants are introduced into a suitable reactor system while products are simultaneously removed from the system. In the present invention at least one siloxane bisphenol, phosgene, at least one metal hydroxide and at least one aqueous soluble metal salt are introduced into a flow reactor and contacted to form a flowing reaction mixture comprising an organic phase and an aqueous phase.

In various embodiments the present invention employs phosgene (COCl₂) to convert siloxane bisphenol hydroxy groups into the corresponding chloroformate groups. It should be noted, however, that other phosgene equivalents may be employed under certain circumstances. Phosgene equivalents include triphosgene, bromochlorophosgene (BrCOCl), and the like. It has been discovered that the amount of phosgene employed strongly influences product yield. In one embodiment the amount of phosgene used corresponds to about It has been discovered that the amount of phosgene employed strongly influences product yield. In one embodiment the amount of phosgene used corresponds to about 2.5 moles to about 6 moles per mole of siloxane bisphenol hydroxy group. In another embodiment the amount of phosgene used corresponds to about 3.5 moles to about 5.5 moles per mole of siloxane bisphenol hydroxy group. In one particular embodiment the amount of phosgene used corresponds to about 3.5 moles to about 5 moles per mole of siloxane bisphenol hydroxy group.

In one embodiment the metal hydroxide used in the reaction comprises alkali metal hydroxide or alkaline earth metal hydroxide, or a combination thereof. The metal hydroxide is introduced into the flow reactor as an aqueous solution. In one embodiment the amount of metal hydroxide used is about 3.5 moles to about 6 moles per mole of phosgene employed. In another embodiment the amount of metal hydroxide used is about 4 moles to about 6 moles per mole of phosgene employed. In one particular embodiment the amount of metal hydroxide used is about 4 moles to about 5 moles per mole of phosgene employed. In one embodiment the concentration of the aqueous metal hydroxide solution employed is about 5 to about 25 percent by weight of the metal hydroxide. In another embodiment the concentration of the aqueous metal hydroxide solution employed is about 17 to about 25 percent by weight of the metal hydroxide. In one particular embodiment the concentration of the metal hydroxide solution is at least about 5 percent by weight. Of course, more concentrated solutions of metal hydroxide may be used, as long as they are supplemented with water such that the net metal hydroxide concentration in aqueous solution is about 25% by weight or less. Suitable metal hydroxides may be selected from the group consisting of but not limited to sodium hydroxide, potassium hydroxide, lithium hydroxide, calcium hydroxide and magnesium hydroxide. In one embodiment the metal hydroxide comprises sodium hydroxide.

In one embodiment the aqueous soluble metal salt employed in the reaction comprises alkali metal halide or alkaline earth metal halide salt or a combination of the foregoing metal halide salts. Suitable metal halide salts may be selected from the group consisting of but not limited to sodium chloride, potassium chloride, calcium chloride, and magnesium chloride. In one embodiment the metal halide salt comprises sodium chloride. In various embodiments the metal halide salt can be introduced into the flow reactor in the form of a solid, as an aqueous solution or in the form of brine. The brine can be obtained from various sources. In one embodiment recycled brine obtained as a by-product of a manufacturing process, such as a condensation polymer manufacturing process may be fed in as a separate feed to the flow reactor. Condensation manufacturing processes that may produce brine as a by-product include, but are not limited to, condensation processes that produce polycarbonates, polyesters, polyarylates, polyamides, polyamideimides, polyetherimides, polyethersulfones, polyetherketones, polyetheretherketones, polyarylene sulfides, polyarylene sulfidesulfones, and the like. In another embodiment brine obtained from natural sources like sea water or brine obtained in the process of mining of brine may be employed. When brine employed is from natural sources in addition to the major quantities of sodium salts it may include salts of magnesium, potassium, calcium, and the like. In one embodiment the amount of metal halide salt added to the flow reactor is such that the aqueous phase is characterized by an initial (i.e. feed) concentration of metal halide salt of at least about 1.5 percent by weight. In another embodiment, the amount of metal halide salt added to the flow reactor is such that the aqueous phase is characterized by an initial concentration of metal halide salt of at least about 5 percent by weight. In yet another embodiment still another embodiment, the amount of metal halide salt added to the flow reactor is such that the aqueous phase is characterized by an initial concentration of metal halide salt of at least about 10 percent by weight. The final (i.e. exit) concentration of the metal halide salt in the aqueous phase in the flow reactor is however dependent on the extent of metal halide salt generated in the reaction taking place during the formation of bischloroformate.

The organic phase in the flowing reaction mixture comprises at least one solvent, which helps to maintain the flow of the reaction mixture in the flow reactor and dissipate heat, among other advantages. The solvent may be a “pure” solvent comprising a single solvent species (e.g. methylene chloride), or the solvent may be a “mixed solvent” comprising two or more solvent species (e.g. a methylene chloride toluene mixture). In various embodiments, the solvent is selected from the group consisting of aliphatic solvents and aromatic solvents. In one embodiment the solvent is selected from the group consisting of C₆-C₁₀ hydrocarbon solvents and C₁-C₁₀ chlorinated solvents. Exemplary C₆-C₁₀ hydrocarbon solvents include benzene, toluene, hexane, heptane, octane, isooctane, decane, xylene, mesitylene, and the like. In one embodiment, the solvent is selected from the group consisting of C₁-C₁₀ chlorinated solvents. Suitable C₁-C₁₀ chlorinated solvents include methylene chloride, ethylene chloride, chloroform, chlorobenzene, chlorotoluene, chloronaphthalene, and the like. In one particular embodiment the solvent employed is methylene chloride.

In one embodiment the siloxane bisphenol is introduced into the flow reactor as a solution in a solvent. Alternatively, the siloxane bisphenol may be introduced into the flow reactor as an oil, without solvent. Alternatively, the siloxane bisphenol may be introduced into the flow reactor as solid, without solvent or as a slurry in a solvent. With reference to the introduction of the siloxane bisphenol into the flow reactor as a solution in a solvent, in one embodiment the concentration of the siloxane bisphenol in the solvent is in a range of about 5 to about 95 percent by weight siloxane bisphenol based on the weight of the solvent. In another embodiment the concentration of the siloxane bisphenol in the solvent is in a range of about 10 to about 70 percent by weight siloxane bisphenol based on the weight of the solvent. In one particular embodiment the concentration of the siloxane bisphenol in the solvent is in a range of about 10 to about 30 percent by weight siloxane bisphenol based on the weight of the solvent. As noted, the siloxane bisphenol employed may be a single chemical species or a mixture of chemical species as is typical in siloxane bisphenols which typically comprise a distribution of bisphenols possessing siloxane subunits of varying chain lengths.

In one embodiment of the present invention the siloxane bisphenol employed comprises Formula I 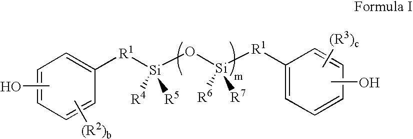
wherein R¹ is independently at each occurrence a C₁-C₁₀ alkylene group optionally substituted by one or more C₁-C₁₀ alkyl or C₆-C₁₀ aryl groups, an oxygen atom, an oxyalkyleneoxy moiety
—O—(CH₂)ₜ—O—,

or an oxyalkylene moiety
—O—(CH₂)ₜ—,

where t is an integer from 2-20; R² and R³ are independently at each occurrence a halogen, a C₁-C₆ alkoxy, C₁-C₆ alkyl, or C₆-C₁₀ aryl; “b” and “c” are independently integers having a value 0 to 4; R⁴, R⁵, R⁶ and R⁷ are independently at each occurrence a C₁-C₆ alkyl, C₆-C₁₀ aryl, C₂-C₆ alkenyl, cyano, trifluoropropyl, or styrenyl; and, and “m” is an integer having a value from 1 to 100.

Suitable siloxane bisphenols that can be employed in the process of the present invention may be selected from the group consisting of eugenol siloxane bisphenol having formula II, 4-allyl-2-methylphenol siloxane bisphenol having formula III, 4-allylphenol siloxane bisphenol having formula IV, 2-allylphenol siloxane bisphenol having formula V, 4-allyloxyphenol siloxane bisphenol having formula VI and 4-vinylphenol siloxane bisphenol having formulas VII and VIII 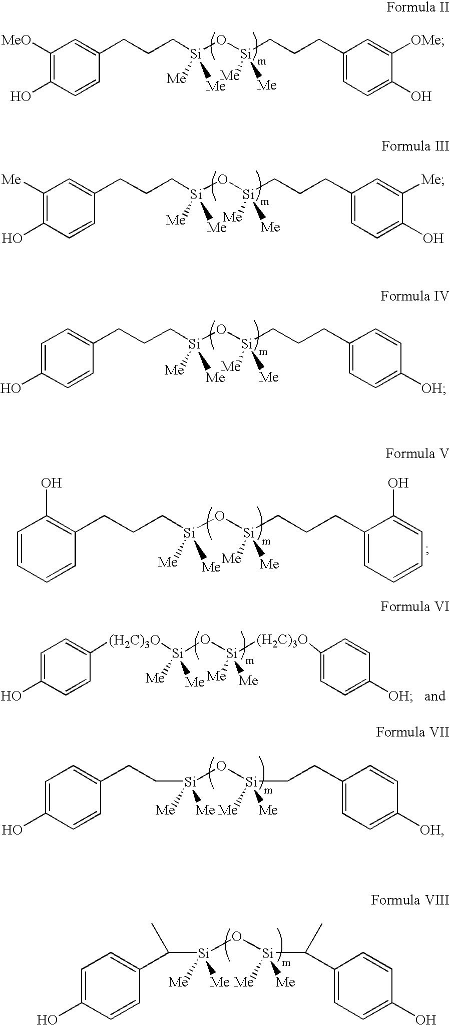
wherein in formulas II, III, IV, V, VI, VII, and VIII “m” is an integer having a value from 1 to 100.

The representative siloxane bisphenols, eugenol siloxane bisphenol II, 4-allyl-2-methylphenol siloxane bisphenol III, 4-allylphenol siloxane bisphenol IV, 2-allylphenol siloxane bisphenol V, 4-allyloxyphenol siloxane bisphenol VI, and 4-vinylphenol siloxane bisphenols VII and VIII are named after the aliphatically unsaturated phenols from which they are prepared. Thus, the name eugenol siloxane bisphenol denotes a siloxane bisphenol prepared from eugenol (4-allyl-2-methoxyphenol). Similarly the name 4-allyl-2-methylphenol siloxane bisphenol indicates the siloxane bisphenol prepared from 4-allyl-2-methylphenol. The other names given follow the same naming pattern.

In one embodiment of the present invention employing eugenol siloxane bisphenol having formula II as a reactant, “m” is an integer between about 20 and about 100. In an alternate embodiment eugenol siloxane bisphenol having formula II has a value of m of 50 said eugenol siloxane bisphenol being represented by the abbreviation EuSiD50. Those skilled in the art will understand that the values given for m in formulas I to VIII represent number average values and that, for example, eugenol siloxane bisphenol having a value of “m” of 50 represents a mixture of siloxane bisphenol homologues having an average value of “m” of 50.

Typically the reactants, siloxane bisphenol, aqueous metal hydroxide, aqueous metal salt solution and phosgene are introduced at one or more upstream positions along the flow reactor. As mentioned, the reactants pass through the flow reactor forming product bischloroformate during the passage from the point at which the reactants are introduced and the point at which an effluent stream containing product emerges from the reactor. The time required for a reactant to travel from the point at which it is introduced to the point at which either it or a product derived from it emerges from the flow reactor is referred to as the reactor residence time. In one embodiment the reactor residence times is in a range between about 5 seconds to about 100 seconds. In another embodiment the reactor residence times is in a range between about 10 seconds to about 50 seconds. In one particular embodiment the reactor residence times is in a range between about 5 seconds to about 30 seconds. Those skilled in the art will understand however that the most preferred residence time will depend upon the structure of the starting siloxane bisphenol, the type of flow reactor employed and the like, and that the most preferred residence time may be determined by straightforward and limited experimentation

In one embodiment the present invention provides a continuous method for the preparation of eugenol siloxane bischloroformate having Formula IX 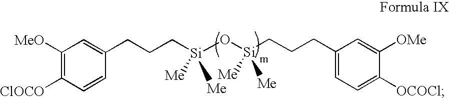
wherein “m” is an integer from 1 to about 100, said method comprising introducing into a flow reactor a solution of eugenol siloxane bisphenol having formula II 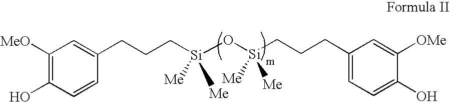
wherein “m” is an integer between 1 and about 100, solution comprising methylene chloride, an aqueous solution comprising sodium hydroxide and a metal halide salt, and phosgene to form a flowing reaction mixture comprising an organic phase and an aqueous phase, said phosgene is being introduced at a rate such that the ratio of phosgene to eugenol siloxane bisphenol hydroxy groups is in a range between about 2.5 and about 6 moles of phosgene per mole of eugenol siloxane bisphenol hydroxy group, said aqueous solution of sodium hydroxide having a concentration of at least about 5 percent by weight sodium hydroxide, said aqueous solution of sodium hydroxide being introduced at a rate such that the molar ratio of metal hydroxide to phosgene is in a range between about 3.5 and about 6; and wherein the aqueous phase is characterized by an initial concentration of metal halide salt of at least about 1.5 percent by weight.

In one embodiment the present invention provides a siloxane bischloroformate comprising structure having Formula X 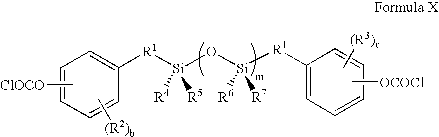
wherein R¹ is independently at each occurrence a C₁-C₁₀ alkylene group optionally substituted by one or more C₁-C₁₀ alkyl or C₆-C₁₀ aryl groups, an oxygen atom, an oxyalkyleneoxy moiety
—O—(CH₂)ₜ—O—,

or an oxyalkylene moiety
—O—(CH₂)ₜ—,

where “t” is an integer from 2-20; R² and R³ are independently at each occurrence a halogen, a C₁-C₆ alkoxy, C₁-C₆ alkyl, or C₆-C₁₀ aryl; “b” and “c” are independently integers having a value 0 to 4; R⁴, R⁵, R⁶ and R⁷ are independently at each occurrence a C₁-C₆ alkyl, C₆-C₁₀ aryl, C₂-C₆ alkenyl, cyano, trifluoropropyl, or styrenyl; and, and “m” is an integer having a value from 1 to 100.

In a further embodiment, the present invention affords high purity bischloroformates having low levels of residual hydroxy endgroups. In one embodiment when siloxane bisphenols having Formula I are converted using the method of the present invention to the corresponding siloxane bischloroformates having Formula X, the product bischloroformate X contains less than 10 percent of residual hydroxy groups. In another embodiment the product bischloroformate having Formula X contains less than 5 percent of residual hydroxy groups. In one particular embodiment the product bischloroformate having Formula X contains less than 1 percent of residual hydroxy groups. The term “residual hydroxy endgroups” refers to those hydroxy groups present in the starting siloxane bisphenol which are not converted to the corresponding chloroformate groups in the product bischloroformate. The principal impurities present in the product siloxane bischloroformate are typically the starting siloxane bisphenol and bischloroformate half product as determined by ¹H-NMR spectroscopy. In a further embodiment the present invention is a siloxane bischloroformate comprising Formula IX wherein “m” is an integer between 1 and about 100, said siloxane bischloroformate comprising fewer than 10 percent hydroxy endgroups, said siloxane bischloroformate comprising less than 0.5 percent carbonate groups.

As noted, the method of the present invention comprises introducing into a flow reactor at least one siloxane bisphenol, at least one solvent, an aqueous solution of at least one metal hydroxide and at least one metal salt, and phosgene and contacting therein to form a product bischloroformate of siloxane bisphenol. For convenience, the siloxane bisphenol, the aqueous solution of at least one metal hydroxide and at least one metal salt, and phosgene are collectively referred to as “the reactants”. The reactants and solvent are typically introduced continuously into the flow reactor to produce a flowing reaction mixture comprising an aqueous phase and an organic phase. Continuous introduction of the reactants and solvent is not required, however. In one embodiment, the introduction of the reactants is carried out in a non-continuous manner. For example, the phosgene may be introduced in a series of discrete pulses with a time interval between each individual introduction of phosgene. The time intervals may be regular time intervals (i.e. be time intervals of equal duration), irregular time intervals, or a combination thereof.

The rates of addition of one or more of the reactants and solvent may be controlled by feedback provided by one or more sensors located in the corresponding feed stream, within the flow reactor, or in the product stream after it emerges from the flow reactor. For example, an excursion in the reactor effluent chloroformate concentration may trigger a change in the rate of addition of one or more of the reactants, for example the metal hydroxide.

The flow reactor used for carrying out the chloroformylation reaction is typically a tube having a front end into which the reactants and solvent are introduced, and a back end from which a product stream emerges from the reactor, but is not limited to tube reactors or tubular reactors. Many types of flow reactors are known and can be used in the practice of the present invention. For example the flow reactor may be a multi-channel flow reactor having a plurality of channels through which the flowing reaction mixture passes. In another embodiment, the flow reactor is a tubular reactor configured with a continuous stirred tank reactor such that the output from the tubular reactor serves as the input for the CSTR. In one embodiment, the flow reactor comprises a single channel having a rectangular-shaped cross section.

Within the flow reactor, a flowing reaction mixture is produced. In one embodiment, although mixing elements may be present within the flow reactor, the flowing reaction mixture may flow essentially in one direction, i.e. from the front end of the reactor to the back end of the reactor. This condition is sometimes also referred to as “co-current flow”. A flowing reaction mixture characterized by co-current flow is typically formed by introducing reactants and solvent into an upstream portion of a flow reactor and removing at a position downstream a product stream containing all of the unreacted reactants, solvent, products, and by-products. The flow reactor may be equipped with a single inlet at the front end of the reactor for the introduction of reactants and solvent. Alternatively, the reactor may comprise a plurality of inlets for the introduction of reactants and solvents.

The reaction may be carried out under substantially adiabatic conditions. By adiabatic conditions it is implied that no heat is gained or lost by the system during the reaction. Adiabatic reactors are strongly preferred over heat exchanger type reactors because of their simplicity and relatively low cost, particularly for commercial operation. However, because the reaction beifg is exothermic, the temperature increases with the extent of reaction (i.e. conversion). This leads to higher reactor pressure because the vapor pressure of solvents, unreacted phosgene, and byproducts such as CO₂ also increases with temperature. Special care needs to be taken to control the maximum temperature in the substantially adiabatic flow reactor, particularly when used with such low-boiling solvents as methylene chloride. Using dilute aqueous solutions of alkali metal hydroxide or alkaline earth metal hydroxide as the acid acceptor helps in controlling the maximum temperature. However, experiments indicate that this results in undesirably low conversion of siloxane bisphenols to the corresponding bischloroformate. Without being bound to theory, the low conversions associated with using dilute aqueous alkali metal hydroxide solutions may be attributed to increased hydrolysis of phosgene due to the increased water content of the dilute alkali metal hydroxide solutions. Surprisingly, it has been observed that by using dilute aqueous solutions of metal hydroxide in the presence of metal salt, significantly higher conversions are achieved than with dilute aqueous solutions of metal hydroxide alone. Also surprisingly, the reactor temperature rise was found to be lower for reactions that were fed with dilute aqueous solutions of alkali metal hydroxide that included metal salt than for reactions fed with dilute aqueous solutions of metal hydroxide that were free of metal salt.

As noted, the flow reactor is not particularly limited and may be any reactor system-that provides for the “upstream” introduction of the reactants and the “downstream” removal of the product stream comprising the bischloroformate of siloxane bisphenol, the solvent, the by-product HCI (or the products of neutralization of HCI by the metal hydroxide), and any unreacted reactants. The flow reactor may comprise a series of flow reactor components, as for example, a series of continuous flow reactors arrayed such that the effluent from a first flow reactor provides the input for a second flow reactor and so forth. The reactants may be introduced into the flow reactor system through one or more feed inlets attached to the flow reactor system. Typically, it is preferred that the reactants and solvent be introduced into the flow reactor through at least three feed inlets. For example, as in the case where a solution of at least one siloxane bisphenol in an organic solvent such as methylene chloride, at least one metal hydroxide and at least one alkali metal salt (as a combined feed stream), and phosgene are introduced through separate feed inlets at or near the upstream end of a flow reactor. Alternatively, the feed solution may comprise a mixture of at least one siloxane bisphenol in an organic solvent such as methylene chloride, at least one metal salt, and at least one metal hydroxide, while phosgene is fed in separately (i.e. four feed streams). Alternative arrangements wherein one or more of the reactants is introduced through multiple feed inlets at various points along the flow reactor are also possible. Typically, the relative amounts of the reactants and solvent present in the flow reactor are controlled by the rate at which they are introduced. For example, reactants can be introduced into the flow reactor through pumps calibrated to deliver the desired feed flow rates. The order or addition of reactants is not particularly critical, but it is generally preferred to introduce the reactants into the flow reactor in the following order: siloxane bisphenol in an organic solvent such as methylene chloride first, followed by phosgene, followed by an aqueous solution of alkali metal hydroxide and metal salt. Alternatively, phosgene and a methylene chloride solution of siloxane bisphenol (e.g. EuSiD50) may be combined upstream of the flow reactor. The optimum feed configuration for a particular application may be determined by those skilled in the art with limited experimentation.

In one embodiment the present invention provides a method for preparing a siloxane copolycarbonate. The method comprises reacting a dihydroxy aromatic compound under interfacial conditions with phosgene and a bischloroformate of siloxane bisphenol. The term “interfacial conditions” is meant to describe the conditions typically used to prepare polycarbonates commercially, namely conditions under which a mixture comprising the salt of a dihydroxy aromatic compound, base, water and a water immiscible solvent are reacted in a two phase reaction mixture with phosgene to afford polycarbonate. Thus in one embodiment, bischloroformate of siloxane bisphenol prepared by the method of the present invention is reacted under interfacial conditions with a dihydroxy aromatic compound and phosgene to afford a siloxane copolycarbonate. In one other embodiment the product bischloroformate of a siloxane bisphenol is used in the interfacial polymerization reaction without further purification. Typically, the interfacial polymerization is carried out at a temperature between about 25° C. and about 45° C. at atmospheric pressure under relatively high pH conditions of about 9-12, preferably about pH 9-11. Generally an acid scavenger is employed which neutralizes the hydrogen chloride formed during the interfacial reaction. Typically the acid scavenger used is an aqueous base, for example, an alkali metal hydroxide. Non-limiting examples of alkali metal hydroxides include sodium hydroxide and potassium hydroxide. In a preferred embodiment the alkali metal hydroxide is sodium hydroxide. A catalyst is employed to promote the interfacial reaction and high yields are generally obtained. Typically, catalysts that may be employed herein are preferably amine catalysts. In one particular embodiment the catalyst is triethylamine (TEA).

In one embodiment the dihydroxy aromatic compound used for preparing the siloxane copolycarbonate comprises at least one bisphenol having formula XI, 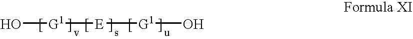
wherein each G¹ is independently at each occurrence a C₆-C₂₀ aromatic radical; E is independently at each occurrence a bond, a C₃-C₂₀ cycloaliphatic radical, a C₃-C₂₀ aromatic radical, a C₁-C₂₀ aliphatic radical, a sulfur-containing linkage, a selenium-containing linkage, a phosphorus-containing linkage, or an oxygen atom; “v” is a number greater than or equal to one; “s” is either zero or one; and “u” is a whole number including zero.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehydes groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e.,—CHO), hexyl, hexamethylene, hydroxymethyl (i.e.,—CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis (cyclohex-4-yl) (i.e., —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex4-yloxy) (i.e., —OC₆H₁₀(CH₂)₆C6H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

The bisphenol represented by Formula XI includes single bisphenols (e.g., BPA) and mixtures of bisphenols (e.g., of BPA and BPZ). In certain embodiments bisphenol represented by Formula XI comprises at least one bisphenol selected from the group consisting of 1,1-bis(4-hydroxyphenyl)cyclopentane; 2,2-bis(3-allyl-4-hydroxyphenyl)propane; 2,2-bis(2-t-butyl-4-hydroxy-5-methylphenyl)propane; 2,2-bis(3-t-butyl-4-hydroxy-6-methylphenyl)propane; 2,2-bis(3-t-butyl-4-hydroxy-6-methylphenyl)butane; 1,3-bis[4-hydroxyphenyl-1-(1-methylethylidine)]benzene; 1,4-bis[4-hydroxyphenyl-1-(1-methylethylidine)]benzene; 1,3-bis[3-t-butyl-4-hydroxy-6-methylphenyl-1-(1-methylethylidine)]benzene; 1,4-bis[3-t-butyl-4-hydroxy-6-methylphenyl-1-(1-methylethylidine)]benzene; 4,4′-biphenol; 2,2′,6,8-tetramethyl-3,3′,5,5′-tetrabromo-4,4′-biphenol; 2,2′,6,6′-tetramethyl-3,3′,5-tribromo-4,4′-biphenol; 1,1-bis(4-hydroxyphenyl)-2,2,2-trichloroethane; 1,1-bis(4-hydroxyphenyl)-1-cyanoethane; 1,1-bis(4-hydroxyphenyl)dicyanomethane; 1,1-bis(4-hydroxyphenyl)-1-cyano-1-phenylmethane; 2,2-bis(3-methyl-4-hydroxyphenyl)propane; 1,1-bis(4-hydroxyphenyl)norbornane; 3,3-bis(4-hydroxyphenyl)phthalide; 1,2-bis(4-hydroxyphenyl)ethane; 1,3-bis(4-hydroxyphenyl)propenone; bis(4-hydroxyphenyl) sulfide; 4,4′-oxydiphenol; 4,4-bis(4-hydroxyphenyl)pentanoic acid; 4,4-bis(3,5-dimethyl-4-hydroxyphenyl)pentanoic acid; 2,2-bis(4-hydroxyphenyl) acetic acid; 2,4′-dihydroxydiphenylmethane; 2-bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane (bisphenol-A); 1,1-bis(4-hydroxyphenyl)propane; 2,2-bis(3-chloro-4-hydroxyphenyl)propane; 2,2-bis(3-bromo-4-hydroxyphenyl)propane; 2,2-bis(4-hydroxy-3-methylphenyl)propane; 2,2-bis(4-hydroxy-3-isopropylphenyl)propane; 2,2-bis(3-t-butyl4-hydroxyphenyl)propane; 2,2-bis(3-phenyl-4-hydroxyphenyl)propane; 2,2-bis(3,5-dichloro-4-hydroxyphenyl)propane; 2,2-bis(3,5-dibromo-4-hydroxyphenyl)propane; 2,2-bis(3,5-dimethyl4-hydroxyphenyl)propane; 2,2-bis(3-chloro-4-hydroxy-5-methylphenyl)propane; 2,2-bis(3-bromo-4-hydroxy-5-methylphenyl)propane; 2,2-bis(3-chloro-4-hydroxy-5-isopropylphenyl)propane; 2,2-bis(3-bromo-4-hydroxy-5-isopropylphenyl)propane; 2,2-bis(3-t-butyl-5-chloro-4-hydroxyphenyl)propane; 2,2-bis(3-bromo-5-t-butyl4-hydroxyphenyl)propane; 2,2-bis(3-chloro-5-phenyl-4-hydroxyphenyl)propane; 2,2-bis(3-bromo-5-phenyl-4-hydroxyphenyl)propane; 2,2-bis(3,5-disopropyl-4-hydroxyphenyl)propane; 2,2-bis(3,5-di-t-butyl-4-hydroxyphenyl)propane; 2,2-bis(3,5-diphenyl-4-hydroxyphenyl)propane; 2,2-bis(4-hydroxy-2,3,5,6-tetrachlorophenyl)propane; 2,2-bis(4-hydroxy-2,3,5,6-tetrabromophenyl)propane; 2,2-bis(4-hydroxy-2,3,5,6-tetramethylphenyl)propane; 2,2-bis(2,6-dichloro-3,5-dimethyl-4-hydroxyphenyl)propane; 2,2-bis(2,6-dibromo-3,5-dimethyl-4-hydroxyphenyl)propane; 2,2-bis(4-hydroxy-3-ethylphenyl)propane; 2,2-bis(4-hydroxy-3,5-dimethylphenyl)propane; 2,2-bis(3,5,3′,5′-tetrachloro-4,4′-dihydroxyphenyl)propane; 1,1-bis(4-hydroxyphenyl)cyclohexylmethane; 2,2-bis(4-hydroxyphenyl)-1-phenylpropane; 1,1-bis(4-hydroxyphenyl)cyclohexane; 1,1-bis(3-chloro-4-hydroxyphenyl)cyclohexane; 1,1-bis(3-bromo-4-hydroxyphenyl)cyclohexane; 1,1-bis(4-hydroxy-3-methylphenyl)cyclohexane; 1,1-bis(4-hydroxy-3-isopropylphenyl)cyclohexane; 1,1-bis(3-t-butyl4-hydroxyphenyl)cyclohexane; 1,1-bis(3-phenyl-4-hydroxyphenyl)cyclohexane; 1,1-bis(3,5-dichloro-4-hydroxyphenyl)cyclohexane; 1,1-bis(3,5-dibromo-4-hydroxyphenyl)cyclohexane; 1,1-bis(3,5-dimethyl-4-hydroxyphenyl)cyclohexane; 4,4′-[1-methyl-4-(1-methyl-ethyl)-1,3-cyclohexandiyl]bisphenol (1,3 BHPM); 4-[1-[3-(4-hydroxyphenyl)-4-methylcyclohexy]-1-methyl-ethyl]-phenol (2,8 BHPM); 3,8-dihydroxy-5a,10b-diphenylcoumarano-2′,3′,2,3-coumarane (DCBP); 2-phenyl-3,3-bis(4-hydroxyphenyl)phthalimidine; 1,1-bis(3-chloro-4-hydroxy-5-methylphenyl)cyclohexane; 1,1-bis(3-bromo-4-hydroxy-5-methylphenyl)cyclohexane; 1,1-bis(3-chloro-4-hydroxy-5-isopropylphenyl)cyclohexane; 1,1-bis(3-bromo4-hydroxy-5-isopropylphenyl)cyclohexane; 1,1-bis(3-t-butyl-5-chloro-4-hydroxyphenyl)cyclohexane; 1,1-bis(3-bromo-5-t-butyl4-hydroxyphenyl)cyclohexane; 1,1-bis(3-chloro-5-phenyl-4-hydroxyphenyl)cyclohexane; 1,1-bis(3-bromo-5-phenyl-4-hydroxyphenyl)cyclohexane; 1,1-bis(3,5-disopropyl-4-hydroxyphenyl)cyclohexane; 1,1-bis(3,5-di-t-butyl-4-hydroxyphenyl)cyclohexane; 1,1-bis(3,5-diphenyl-4-hydroxyphenyl)cyclohexane; 1,1-bis(4-hydroxy-2,3,5,6-tetrachlorophenyl)cyclohexane; 1,1-bis(4-hydroxy-2,3,5,6-tetrabromophenyl)cyclohexane; 1,1-bis(4-hydroxy-2,3,5,6-tetramethylphenyl)cyclohexane; 1,1-bis(2,6-dichloro-3,5-dimethyl-4-hydroxyphenyl)cyclohexane; 1,1-bis(2,6-dibromo-3,5-dimethyl-4-hydroxyphenyl)cyclohexane; 1,1-bis(4-hydroxyphenyl)-3,3,5-trimethylcyclohexane; 1,1-bis(3-chloro-4-hydroxyphenyl)-3,3,5-trimethylcyclohexane; 1,1-bis(3-bromo-4-hydroxyphenyl)-3,3,5-trimethylcyclohexane; 1,1-bis(4-hydroxy-3-methylphenyl)-3,3,5-trimethylcyclohexane; 1,1-bis(4-hydroxy-3-isopropylphenyl)-3,3,5-trimethylcyclohexane; 1,1-bis(3-t-butyl-4-hydroxyphenyl)-3,3,5-trimethylcyclohexane; 1,1-bis(3-phenyl-4-hydroxyphenyl)-3,3,5-trimethylcyclohexane; 1,1-bis(3,5-dichloro-4-hydroxyphenyl)-3,3,5-trimethylcyclohexane; 1,1-bis(3,5-dibromo-4-hydroxyphenyl)-3,3,5-trimethylcyclohexane; 1,1-bis(3,5-dimethyl-4-hydroxyphenyl)-3,3,5-trimethylcyclohexane; 1,1-bis(3-chloro-4-hydroxy-5-methylphenyl)-3,3,5-trimethylcyclohexane; 1,1-bis(3-bromo-4-hydroxy-5-methylphenyl)-3,3,5-trimethylcyclohexane; 1,1-bis(3-chloro-4-hydroxy-5-isopropylphenyl)-3,3,5-trimethylcyclohexane; 1,1-bis(3-bromo-4-hydroxy-5-isopropylphenyl)-3,3,5-trimethylcyclohexane; 1,1-bis(3-t-butyl-5-chloro-4-hydroxyphenyl)-3,3,5-trimethylcyclohexane; 1,1-bis(3-bromo-5-t-butyl-4-hydroxyphenyl)-3,3,5-trimethylcyclohexane; bis(3-chloro-5-phenyl-4-hydroxyphenyl)-3,3,5-trimethylcyclohexane; 1,1-bis(3-bromo-5-phenyl-4-hydroxyphenyl)-3,3,5-trimethylcyclohexane; 1,1-bis(3,5-disopropyl-4-hydroxyphenyl)-3,3,5-trimethylcyclohexane; 1,1-bis(3,5-di-t-butyl-4-hydroxyphenyl)-3,3,5-trimethylcyclohexane; 1,1-bis(3,5-diphenyl-4-hydroxyphenyl)-3,3,5-trimethylcyclohexane; 1,1-bis(4-hydroxy-2,3,5,6-tetrachlorophenyl)-3,3,5-trimethylcyclohexane; 1,1-bis(4-hydroxy-2,3,5,6-tetrabromophenyl)-3,3,5-trimethylcyclohexane; 1,1-bis(4-hydroxy-2,3,5,6-tetramethylphenyl)-3,3,5-trimethylcyclohexane; 1,1-bis(2,6-dichloro-3,5-dimethyl-4-hydroxyphenyl)-3,3,5-trimethylcyclohexane; 1,1-bis(2,6-dibromo-3,5-dimethyl-4-hydroxyphenyl)-3,3,5-trimethylcyclohexane; 4,4-bis(4-hydroxyphenyl)heptane; 1,1-bis(4-hydroxyphenyl)decane; 1,1-bis(4-hydroxyphenyl)cyclododecane; 1,1-bis(3,5-dimethyl-4-hydroxyphenyl)cyclododecane; 4,4′dihydroxy-1,1-biphenyl; 4,4′-dihydroxy-3,3′-dimethyl-1,1-biphenyl; 4,4′-dihydroxy-3,3′-dioctyl-1,1-biphenyl; 4,4′-(3,3,5-trimethylcyclohexylidene)diphenol; 4,4′-bis(3,5-dimethyl)diphenol; 4,4′-dihydroxydiphenylether; 4,4′-dihydroxydiphenylthioether;1,3-bis(2-(4-hydroxyphenyl)-2-propyl)benzene; 1,3-bis(2-(4-hydroxy-3-methylphenyl)-2-propyl)benzene; 1,4-bis(2-(4-hydroxyphenyl)-2-propyl)benzene; 1,4-bis(2-(4-hydroxy-3-methylphenyl)-2-propyl)benzene; 2,4′-dihydroxyphenyl sulfone; 4,4′-dihydroxydiphenylsulfone (BPS); bis(4-hydroxyphenyl)methane; 2,6-dihydroxy naphthalene; hydroquinone; resorcinol; C₁₋₃ alkyl-substituted resorcinols; 3-(4-hydroxyphenyl)-1,1,3-trimethylindan-5-ol; 1-(4-hydroxyphenyl)-1,3,3-trimethylindan-5-ol; 4,4-dihydroxydiphenyl ether; 4,4-dihydroxy-3,3-dichlorodiphenylether; 4,4-dihydroxy-2,5-dihydroxydiphenyl ether; 4,4-thiodiphenol; 2,2,2′,2′-tetrahydro-3,3,3′,3′-tetramethyl-1,1′-spirobi[1H-indene]-6,6′-diol; and mixtures thereof.

In one embodiment of the present invention, the siloxane copolycarbonates prepared using the bischloroformate of siloxane bisphenol of the present invention may be further employed to prepare polymer compositions. In one embodiment, the polymer compositions provided by the present invention comprise one or more additional resins selected from the group consisting of polyamides, polyesters, polycarbonates; olefin polymers such as ABS, polystyrene, polyethylene; polysiloxanes, polysilanes and polysulfones. In certain embodiments the one or more additional resins may be present preferably in an amount less than or equal to 40 weight percent, more preferably less than or equal to 35 weight percent and most preferably less than or equal to about 30 weight percent based on the total weight of the polymer composition.

In various embodiments, the siloxane copolycarbonates and polymer compositions comprising said siloxane copolycarbonates provided by the present invention may be compounded with various additives, which may be used alone or in combination. Thus, in one embodiment the present invention provides a siloxane copolycarbonate composition comprising at least one additive. In an alternate embodiment, the present invention provides a polymer composition comprising at least one siloxane copolycarbonate, at least one additional resin, and at least one additive. Suitable additives include such materials as thermal stabilizers, antioxidants, UV stabilizers, plasticizers, visual effect enhancers, extenders, antistatic agents, catalyst quenchers, mold releasing agents, fire retardants, blowing agents, impact modifiers and processing aids. The different additives that can be incorporated in the polymer compositions of the present invention are typically commonly used and known to those skilled in the art.

Visual effect enhancers, sometimes known as visual effects additives or pigments may be present in an encapsulated form, a non-encapsulated form, or laminated to a particle comprising polymeric resin. Some non-limiting examples of visual effects additives are aluminum, gold, silver, copper, nickel, titanium, stainless steel, nickel sulfide, cobalt sulfide, manganese sulfide, metal oxides, white mica, black mica, pearl mica, synthetic mica, mica coated with titanium dioxide, metal-coated glass flakes, and colorants, including but not limited, to Perylene Red. The visual effect additive may have a high or low aspect ratio and may comprise greater than 1 facet. Dyes may be employed such as Solvent Blue 35, Solvent Blue 36, Disperse Violet 26, Solvent Green 3, Anaplast Orange LFP, Perylene Red, and Morplas Red 36. Fluorescent dyes may also be employed including, but not limited to, Permanent Pink R (Color Index Pigment Red 181, from Clariant Corporation), Hostasol Red 5B (Color Index #73300, CAS # 522-75-8, from Clariant Corporation) and Macrolex Fluorescent Yellow 10GN (Color Index Solvent Yellow 160:1, from Bayer Corporation). Pigments such as titanium dioxide, zinc sulfide, carbon black, cobalt chromate, cobalt titanate, cadmium sulfides, iron oxide, sodium aluminum sulfosilicate, sodium sulfosilicate, chrome antimony titanium rutile, nickel antimony titanium rutile, and zinc oxide may be employed. Visual effect additives in encapsulated form usually comprise a visual effect material such as a high aspect ratio material like aluminum flakes encapsulated by a polymer. The encapsulated visual effect additive has the shape of a bead.

Non-limiting examples of antioxidants that can be used in the polymer compositions of the present invention include tris(2,4-di-tert-butylphenyl)phosphite; 3,9-di(2,4-di-tert-butylphenoxy)-2,4,8,10-tetraoxa-3,9-diphosphaspiro[5.5]undecane; 3,9-di(2,4-dicumylphenoxy)-2,4,8,10-tetraoxa-3,9-diphosphaspiro[5.5]undecane; tris(p-nonylphenyl)phosphite; 2,2′,2″-nitrilo[triethyl-tris[3,3′,5,5′-tetra-tertbutyl-1,1′-biphenyl-2′-diyl]phosphite]; 3,9-distearyloxy-2,4,8,10-tetraoxa-3,9-diphosphaspiro[5.5]undecane; dilauryl phosphite; 3,9-di[2,6-di-tert-butyl-4-methylphenoxy]-2,4,8,10-tetraoxa-3,9-diphosphaspiro[5.5]undecane; tetrakis(2,4-di-tert-butylphenyl)-4,4′-bis(diphenylene)phosphonite; distearyl pentaerythritol diphosphite; diisodecyl pentaerythritol diphosphite; 2,4,6-tri-tert-butylphenyl-2-butyl-2-ethyl-1,3-propanediol phosphite; tristearyl sorbitol triphosphite; tetrakis(2,4-di-tert-butylphenyl)-4,4′-biphenylene diphosphonite; (2,4,6-tri-tert-butylphenyl)-2-butyl-2-ethyl-1,3-propanediolphosphite; triisodecylphosphite; and mixtures of phosphites containing at least one of the foregoing.

The polymer composition may optionally comprise an impact modifier. The impact modifier resin added to the polymer composition in an amount corresponding to about 1% to about 30% by weight, based on the total weight of the composition. Suitable impact modifiers include those comprising one of several different rubbery modifiers such as graft or core shell rubbers or combinations of two or more of these modifiers. Impact modifiers are illustrated by acrylic rubber, ASA rubber, diene rubber, organosiloxane rubber, ethylene propylene diene monomer (EPDM) rubber, styrene-butadiene-styrene (SBS) rubber, styrene-ethylene-butadiene-styrene (SEBS) rubber, acrylonitrile-butadiene-styrene (ABS) rubber, methacrylate-butadiene-styrene (MBS) rubber, styrene acrylonitrile copolymer and glycidyl ester impact modifier.

The term “acrylic rubber modifier” may refer to multi-stage, core-shell, interpolymer modifiers having a cross-linked or partially crosslinked (meth)acrylate rubbery core phase, preferably butyl acrylate. Associated with this cross-linked acrylic ester core is an outer shell of an acrylic or styrenic resin, preferably methyl methacrylate or styrene, which interpenetrates the rubbery core phase. Incorporation of small amounts of other monomers such as acrylonitrile or (meth)acrylonitrile within the resin shell also provides suitable impact modifiers. The interpenetrating network is provided when the monomers forming the resin phase are polymerized and cross-linked in the presence of the previously polymerized and cross-linked (meth)acrylate rubbery phase.

Suitable impact modifiers are graft or core shell structures with a rubbery component with a Tg below 0° C., preferably between about −40° to −80° C., composed of poly alkylacrylates or polyolefins grafted with polymethylmethacrylate (PMMA) or styrene acrylonitrile (SAN). Preferably the rubber content is at least 10 wt %, more preferably greater than 40 wt %, and most preferably between about 40 and 75 wt %.

Other suitable impact modifiers are the butadiene core-shell polymers of the type available from Rohm & Haas, for example Paraloid® EXL2600. Most suitable impact modifier will comprise a two stage polymer having a butadiene based rubbery core and a second stage polymerized from methylmethacrylate alone or in combination with styrene. Other suitable rubbers are the ABS types Blendex® 336 and 415, available from GE Specialty Chemicals. Both rubbers are based on impact modifier resin of SBR rubber. Although several rubbers have been described, many more are commercially available. Any rubber may be used as an impact modifier as long as the impact modifier does not negatively impact the physical or aesthetic properties of the thermoplastic composition.

Non-limiting examples of processing aids that can be used include Doverlube® FL-599 (available from Dover Chemical Corporation), Polyoxyter® (available from Polychem Alloy Inc.), Glycolube P (available from Lonza Chemical Company), pentaerythritol tetrastearate, Metablen A-3000 (available from Mitsubishi Rayon), neopentyl glycol dibenzoate, and the like.

Non-limiting examples of UV stabilizers that can be used include 2-(2′-Hydroxyphenyl)-benzotriazoles, e.g., the 5′-methyl-; 3′,5′-di-tert.-butyl-; 5′-tert.-butyl-; 5′-(1,1,3,3-tetramethylbutyl)-; 5-chloro-3′,5′-di-tert.-butyl-; 5-chloro-3′-tert.-butyl-5′-methyl-; 3′-sec.-butyl-5′-tert.-butyl-; 3′-alpha -methylbenzyl-5′-methyl; 3′-alpha-methylbenzyl-5′-methyl-5-chloro-; 4′-hydroxy-; 4′-methoxy-; 4′-octoxy-; 3′,5′-di-tert.-amyl-; 3′-methyl-5′-carbomethoxyethyl-; 5-chloro-3′,5′-di-tert.-amyl-derivatives; and Tinuvin® 234 (available from Ciba Specialty Chemicals). Also suitable are the 2,4-bis-(2′-hydroxyphenyl)-6-alkyl-s-triazines, e.g., the 6-ethyl-; 6-heptadecyl- or 6-undecyl-derivatives. 2-Hydroxybenzophenones e.g., the 4-hydroxy-; 4-methoxy-; 4-octoxy-; 4-decyloxy-; 4-dodecyloxy-; 4-benzyloxy-; 4,2′,4′-trihydroxy-; 2,2′,4,4′-tetrahydroxy- or 2′-hydroxy-4,4′-dimethoxy-derivative. 1,3-bis-(2′-Hydroxybenzoyl)-benzenes, e.g., 1,3-bis-(2′-hydroxy-4′-hexyloxy-benzoyl)-benzene; 1,3-bis-(2′-hydroxy-4′-octyloxy-benzoyl)-benzene or 1,3-bis-(2′-hydroxy-4′-dodecyloxybenzoyl)-benzene may also be employed. Esters of optionally substituted benzoic acids, e.g., phenylsalicylate; octylphenylsalicylate; dibenzoylresorcin; bis-(4-tert.-butylbenzoyl)-resorcin; benzoylresorcin; 3,5-di-tert.-butyl-4-hydroxybenzoic acid-2,4-di-tert.-butylphenyl ester or -octadecyl ester or -2-methyl4,6-di-tert.-butyl ester may likewise be employed. Acrylates, e.g., alpha -cyano-beta, beta -diphenylacrylic acid-ethyl ester or isooctyl ester, alpha -carbomethoxy-cinnamic acid methyl ester, alpha-cyano-beta-methyl-p-methoxy-cinnamic acid methyl ester or -butyl ester or N(beta-carbomethoxyvinyl)-2-methyl-indoline may likewise be employed. Oxalic acid diamides, e.g., 4,4′-di-octyloxy-oxanilide; 2,2′-di-octyloxy-5,5′-di-tert.-butyl-oxanilide; 2,2′-di-dodecyloxy-5,5-di-tert.-butyl-oxanilide; 2-ethoxy-2′-ethyl-oxanilide; N,N′-bis-(3-dimethyl-aminopropyl)-oxalamide; 2-ethoxy-5-tert.-butyl-2′-ethyloxanilide and the mixture thereof with 2-ethoxy-2′-ethyl-5,4′-di-tert.-butyl-oxanilide; or mixtures of ortho- and para-methoxy- as well as of o- and p-ethoxy-disubstituted oxanilides are also suitable as UV stabilizers. Preferably the ultraviolet light absorber used in the instant compositions is 2-(2-hydroxy-5-methylphenyl)-2H-benzotriazole; 2-(2-hydroxy-3,5-di-tert-amylphenyl)-2H-benzotriazole; 2-[2-hydroxy-3,5-di-(alpha,alpha-dimethylbenzyl)phenyl]-2H-benzotriazole; 2-(2-hydroxy-5-tert-octylphenyl)-2H-benzotriazole; 2-hydroxy-4-octyloxybenzophenone; nickel bis(O-ethyl 3,5-di-tert-butyl4-hydroxybenzylphosphonate); 2,4-dihydroxybenzophenone; 2-(2-hydroxy-3-tert-butyl-5-methylphenyl)-2H-benzotriazole; nickel butylamine complex with 2,2′-thiobis(4-tert-butylphenol); 2-ethoxy-2′-ethyloxanilide; 2-ethoxy-2′-ethyl-5,5′-ditert-butyloxanilide or a mixture thereof.

Non-limiting examples of fire retardants that can be used include potassium diphenylsulfone sulfonate, and phosphite esters of polyhydric phenols, such as resorcinol and bisphenol A.

Non-limiting examples of mold release compositions include esters of long-chain aliphatic acids and alcohols such as pentaerythritol, guerbet alcohols, long-chain ketones, siloxanes, alpha.-olefin polymers, long-chain alkanes and hydrocarbons having 15 to 600 carbon atoms.

### EXAMPLES

The following examples are set forth to provide those of ordinary skill in the art with a detailed description of how the methods claimed herein are evaluated, and are not intended to limit the scope of what the inventors regard as their invention. Unless indicated otherwise, parts are by weight, temperature is in ° C.

Molecular weights are reported as number average (Mₙ) or weight average (M_{w}) molecular weight and were determined by gel permeation chromatography (GPC) analysis, using polystyrene molecular weight standards to construct a standard calibration curve against which polymer molecular weights were determined. The temperature of the gel permeation columns was about 25° C. and the mobile phase was chloroform.

In interfacial polymerization reactions a Mettler glass electrode was used to maintain the pH at the appropriate value. The electrode was calibrated at pH 7 and pH 10 using standard pH buffer solutions.

The general procedure for the preparation of bischloroformates of eugenol siloxane in all Examples is detailed below. The flow reactor comprised a series of two Ko-Flo® long static mixers (⅜ inch o.d×17 inches each; total reactor volume 37.7 mL). The flow reactor was covered with a cylindrical one-inch thick fiberglass insulating jacket. A feed solution EuSiD49.3 in methylene chloride (20 weight percent solution was pre-cooled to 7-10° C. by passing through a heat-exchanger immersed in ice/water bath and introduced into the flow reactor. An aqueous feed containing specific weight percents of sodium hydroxide and sodium chloride was independently introduced into the reactor at ambient temperature (20° C.). Phosgene (20° C.) was introduced into the flow reactor at a specific flow rate, independent of other reactants. Residence time in the flow reactor varied depending on the flow rates of the components being fed and the number of mixing sections used. The pressure at the feed side of the reactor was 3-5 psig. The reactor effluent was quenched in 2 N HCI and the conversion to chloroformate was quantified by proton NMR. The product collection/quench vessel was vented to an aqueous caustic scrubber. The bischloroformates formed had nondetectable levels of coupled (carbonate) product. The reaction conditions and results are tabulated in Table 1 below.

TABLE 1

| | | | Wt % | Wt % | | | | | | Max | |
|---|---|---|---|---|---|---|---|---|---|---|---|
| | | | NaOH in | NaCl in | | gm/min | Residence | | Feed | Tube | Temp |
| | | | Aqueous | Aqueous | gm/min | aqueous | Time | % | Temp, | temp | Increase, |
| Example | Rₚ^{a} | R_{q}^{b} | Feed | Feed | COCl₂ | feed | (sec) | Conv^{c} | ° C. | ° C. | ° C. |
| 1 | 4 | 5 | 10 | 10 | 3 | 60.7 | 19 | 95.7 | 24.0 | 39.8 | 15.8 |
| CE-1 | ″ | ″ | ″ | 0 | ″ | ″ | ″ | 88.4 | 24.6 | 41.0 | 16.4 |
| 2 | 4 | 4 | 10 | 10 | 3 | 48.5 | 21 | 94.3 | 24.7 | 39.8 | 15.1 |
| CE-2 | ″ | ″ | ″ | 0 | ″ | ″ | ″ | 88.1 | 20.0 | 40.7 | 20.7 |
| 3 | 5 | 3.5 | 10 | 10 | 3.75 | 53.7 | 20 | 100 | 26.7 | 36.9 | 10.2 |
| CE-3 | ″ | ″ | ″ | 0 | ″ | ″ | ″ | 94.3 | 28.2 | 39.6 | 11.4 |
| 4 | 4 | 3 | 15 | 1.5 | 3.0 | 32.3 | 24 | 95.2 | 22.8 | 40.2 | 17.4 |
| CE-4 | ″ | ″ | ″ | 0 | ″ | ″ | ″ | 92.6 | 22.1 | 39.6 | 17.5 |
| 5 | 5 | 4.1 | 15 | 5 | 3.75 | 41.5 | 22 | 100 | 20.6 | 41.9 | 21.3 |
| CE-5 | ″ | ″ | ″ | 0 | ″ | ″ | ″ | 96.4 | 17.6 | 40.5 | 22.9 |

^{a}mole phosgene/mole eugenol hydroxyl group
^{b}mole sodium hydroxide/mole phosgene
^{c}conversion to chloroformate

Examples 1 and CE-1 were run under similar conditions except that example 1 utilized the addition of sodium chloride to the aqueous caustic feed. Example 1 showed significantly higher conversion to chloroformate and a lower temperature increase than example CE-1. The same effect is seen in pairs of examples (example 2 and CE-2 through example 5 and CE-5). These examples demonstrate that reactions that utilize dilute aqueous sodium hydroxide to which sodium chloride has been added result in a lower temperature rise and a higher conversion to chloroformate, compared with reactions run under comparable conditions to which no sodium chloride has been added.

The invention has been described in detail with particular reference to preferred embodiments thereof, but it will be understood by those skilled in the art that variations and modifications can be effected within the spirit and scope of the invention.

What is claimed is:

1. A continuous method for the preparation of bischloroformates of siloxane bisphenols, said method comprising
introducing into a flow reactor and contacting therein at least one siloxane bisphenol, at least one metal hydroxide, at least one metal salt, at least one solvent, and phosgene to form a flowing reaction mixture having an organic phase and an aqueous phase and forming bischloroformates of siloxane bisphenols in the flowing reaction mixture,
wherein said phosgene is introduced at a rate such that the ratio of phosgene to siloxane bisphenol hydroxy groups is in a range between about 2.5 and about 6 moles of phosgene per mole of siloxane bisphenol hydroxy group,
wherein said metal hydroxide is introduced as an aqueous solution, said aqueous solution having a concentration of at least about 5 percent by weight metal hydroxide, said metal hydroxide being introduced at a rate such that the molar ratio of metal hydroxide to phosgene is in a range between about 3.5 and about 6; and
wherein the aqueous phase has an initial concentration of metal salt of at least about 1.5 percent by weight.

2. The method according to claim 1 wherein less than 0.5 mole percent of the bisphenol siloxane groups are converted to the corresponding carbonate.

3. The method according to claim 1, wherein said contacting is carried out under adiabatic conditions.

4. The method according to claim 1 wherein said siloxane bisphenol comprises a compound represented by formula I 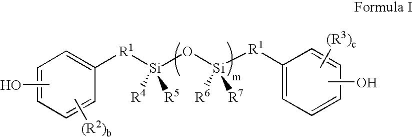
wherein R¹ is independently at each occurrence a C₁-C₁₀ alkylene group optionally substituted by one or more C₁-C₁₀ alkyl or C₆-C₁₀ aryl groups an oxygen atom; an oxyalkyleneoxy moiety
—O—(CH₂)ₜ—O—,
or an oxyalkylene moiety
—O—(CH₂)ₜ—,
where t is an integer from 2-20; R² and R³ are independently at each occurrence a halogen, a C₁-C₆ alkoxy, C₁-C₆ alkyl, or C₆-C₁₀ aryl ; “b” and “c” are independently integers having a value 0 to 4; R⁴, R⁵, R⁶ and R⁷ are independently at each occurrence a C₁-C₆ alkyl, C₆-C₁₀ aryl, C₂-C₆ alkenyl, cyano, trifluoropropyl, or styrenyl; and, and “m” is an integer having a value from 1 to 100.

5. A method according to claim 4 wherein said siloxane bisphenol is a eugenol siloxane bisphenol having Formula II 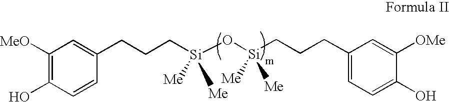
wherein m is an integer from 1 to about 100.

6. A method according to claim 5 wherein “m” is an integer from about 10 to about 100.

7. A method according to claim 5 wherein said siloxane bisphenol is selected from the group consisting of 4-allyl-2-methylphenol siloxane bisphenol having formula III, 4-allylphenol siloxane bisphenol having formula IV, 2-allylphenol siloxane bisphenol having formula V, 4-allyloxyphenol siloxane bisphenol having formula VI and 4-vinylphenol siloxane bisphenol having Formulas VII and VIII, 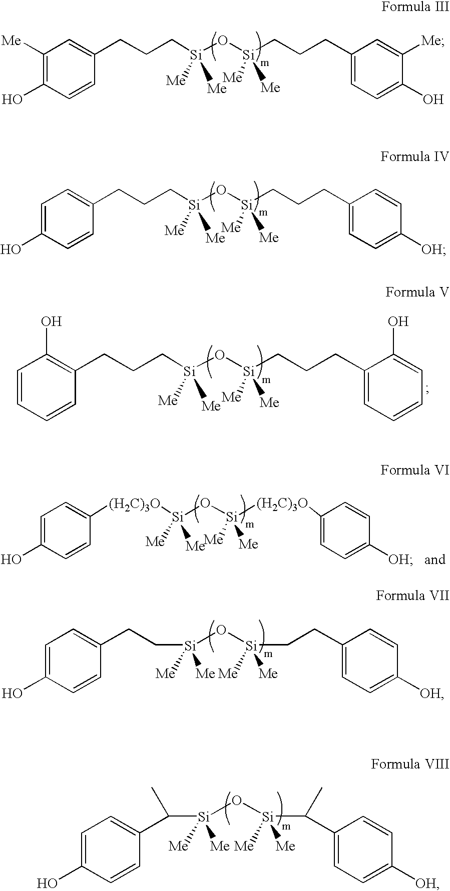
wherein in formula III, IV, V, VI, VII and VIII, “m” is an integer having a value from 1 to 100.

8. The method according to claim 1 wherein said solvent is selected from halogenated aliphatic solvents, non-halogenated aliphatic solvents, halogenated aromatic solvents, non-halogenated aromatic solvents, and mixtures thereof.

9. The method according to claim 1 wherein said siloxane bisphenol is introduced into said flow reactor as a solution in an organic solvent.

10. The method according to claim 1 wherein said organic phase comprises a solvent selected from the group consisting of methylene chloride, chloroform, 1,2-dichloroethane, toluene and ethylacetate.

11. The method according to claim 1 wherein said metal hydroxide comprises at least one alkali metal hydroxide or at least one alkaline earth metal hydroxide.

12. The method according to claim 1, said method being further characterized as having a reactant residence time, said residence time being in a range between about 5 seconds and about 100 seconds.

13. A continuous method for the preparation of eugenol siloxane bischloroformate having formula IX 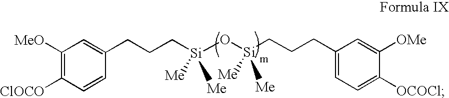
wherein “m” is an integer from 1 to about 100,
said method comprising introducing into a flow reactor and contacting therein a solution of eugenol siloxane bisphenol having formula II 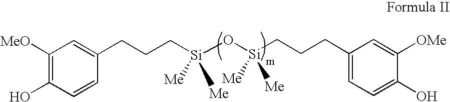
wherein “m” is an integer between 1 and about 100, said solution comprising methylene chloride, an aqueous solution comprising sodium hydroxide and metal halide salt, and phosgene to form a flowing reaction mixture having an organic phase and an aqueous phase, said phosgene is being introduced at a rate such that the ratio of phosgene to eugenol siloxane bisphenol hydroxy groups is in a range between about 2.5 and about 6 moles of phosgene per mole of eugenol siloxane bisphenol hydroxy group, said aqueous solution of sodium hydroxide having a concentration of at least about 5 percent by weight sodium hydroxide, said aqueous solution of sodium hydroxide being introduced at a rate such that the molar ratio of metal hydroxide to phosgene is in a range between about 3.5 and about 6; and wherein the aqueous phase is characterized by an initial concentration of metal halide salt of at least about 1.5 percent by weight.

14. The method according to claim 13, said method being further characterized as having a reactant residence time, said residence time being in a range between about 5 seconds and about 100 seconds.

15. The method according to claim 13 wherein said solution of eugenol siloxane bisphenol comprising methylene chloride comprises about 20 percent by weight eugenol siloxane bisphenol, formula II.

16. The method according to claim 13 wherein said aqueous solution of sodium hydroxide comprises from about 5 to about 20 percent by weight sodium hydroxide.

17. The method according to claim 13 in which said flow reactor is selected from the group consisting of one or more tubular reactors, one or more continuous stirred tank reactors, one or more loop reactors, a column reactor, or a combination thereof.

18. The method according to claim 13 wherein said flow reactor comprises a series of tubular reactors.

19. The method according to claim 13 wherein said flow reactor comprises a series of continuous stirred tank reactors.

20. The method according to claim 13 wherein said metal halide salt is sodium chloride.

21. A method for preparing a siloxane copolycarbonate said method comprising:
reacting under interfacial conditions at least one dihydroxy aromatic compound, phosgene, at least one metal hydroxide, and at least one siloxane bischloroformate;
said siloxane bischloroformate having been prepared by a continuous method for the preparation of bischloroformates of siloxane bisphenols, said method comprising
introducing into a flow reactor and contacting therein at least one siloxane bisphenol, at least one metal hydroxide, at least one metal halide salt, at least one solvent and phosgene to form a flowing reaction mixture having an organic phase and an aqueous phase and forming bischloroformates of siloxane bisphenols in the flowing reaction mixture,
wherein said phosgene is introduced at a rate such that the ratio of phosgene to siloxane bisphenol hydroxy groups is in a range between about 2.5 and about 6 moles of phosgene per mole of siloxane bisphenol hydroxy group,
wherein said metal hydroxide is introduced as an aqueous solution, said aqueous solution having a concentration of at least about 5 percent by weight metal hydroxide, said metal hydroxide being introduced at a rate such that the molar ratio of metal hydroxide to phosgene is in a range between about 3.5 and about 6; and
wherein the aqueous phase is characterized by an initial concentration of metal halide salt of at least about 1.5 percent by weight.

22. The method according to claim 21 wherein the bischloroformate is used in its entirety and without purification.

23. The method according to claim 21 wherein said dihydroxy aromatic compound is a bisphenol having formula (XI); 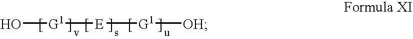
wherein each G¹ is independently at each occurrence a C₆-C₂₀ aromatic radical; E is independently at each occurrence a bond, a C₃-C₂₀ cycloaliphatic radical, a C₆-C₂₀ aromatic radical, a C₁-C₂₀ aliphatic radical, a sulfur-containing linkage, a selenium-containing linkage, a phosphorus-containing linkage, or an oxygen atom; “v” is a number greater than or equal to one; “s” is either zero or one; and “u” is a whole number including zero.
